(19) United States
(12) Patent Application Publication
(10) Pub. No.: US 2026/0166724 A1
(43) Pub. Date: Jun. 18, 2026

(54) POSE ESTIMATION USING CONDITIONAL FEATURES

(71) Applicant: Intrinsic Innovation LLC, Mountain View, CA (US)

(72) Inventors: Dmitrii Marin, Toronto (CA); Agastya Kalra, Palo Alto, CA (US)

(21) Appl. No.: 18/980,863

(22) Filed: Dec. 13, 2024

(51) Int. Cl. B25J 9/16; G05B 13/02

(52) U.S. Cl. CPC B25J 9/163; B25J 9/1664; G05B 13/0265

(57) ABSTRACT

Methods, systems, and apparatus, including computer programs encoded on computer storage media, for partitioning object orientation space into subspaces to eliminate pose ambiguity. One of the methods includes receiving a request to generate a predicted pose of the object. Using data representing M base pose subspaces that partition the object orientation space of the object and one or more images of the object from one of more respective viewpoints belonging to the base pose subspace, generating a predicted pose for each base pose subspace from features obtained from the images of the object. A final predicted pose is provided by computing a respective confidence value for each predicted pose for the M base pose subspaces.

### BACKGROUND

This specification relates to estimating poses for one or more objects in robotic systems using machine learning techniques.

Robotic manipulation tasks often heavily rely on sensor data. For example, a warehouse robot that moves boxes can be programmed to use camera data to pick up a box at the entrance of a warehouse, move, and put it down in a target zone of the warehouse. For another example, a construction robot can be programmed to use camera data to pick up a beam and put it down on a bridge deck. The sensor data can be further used to estimate a pose of an object in a robotic system.

Six degree-of-freedom (6DoF) pose estimation systems can take as input a set of images of a scene taken from different cameras with different viewpoints. These systems aim to output a 6DoF pose estimation of one or more target objects visible in the scene, which typically include three coordinates for position and three coordinates for orientation. However, pose estimation is challenging when the pose of the object from some viewpoints is ambiguous.

This is a particular problem for keypoints-based pose estimation systems that rely on matching keypoints obtained from multiple different images of an object. The ambiguous poses can introduce highly inaccurate keypoint estimations, which can prevent the system from obtaining an accurate pose or prevent the system from obtaining any solution at all.

### SUMMARY

This specification describes how a 6DoF pose estimation visual system can partition object spaces into subspaces to solve pose ambiguity problems. More specifically, the system obtains images from multiple viewpoints of the object within each partitioned subspace and generates features from each image on the condition that the object's pose belongs to each respective partitioned subspace. The pose prediction subsystem can then generate multiple predicted poses from the extracted features to determine the best pose.

In this specification, a pose for an object generally represents a location and an orientation of the object. For example, a pose can include values for one or more translation degrees of freedom (DOFs) and values for one or more rotational DOFs. A translational DOF can represent a position along the x, y, or z orthogonal axis in a suitable coordinate system (e.g., Cartesian coordinate system). A rotational DOFs can represent a rotation around the x, y or z axis in a suitable coordinate system. Six degrees of freedom (6DoF) refers to the three translation DOFs (i.e., on x, y, or z axis) and the three rotational DOFs.

Particular embodiments of the subject matter described in this specification can be implemented so as to realize one or more of the following advantages. The visual system is simplified as it has to account for a much smaller subspace of object orientations. Moreover, subspaces can be chosen such that there is no ambiguity within each of them. The delayed disambiguation step obtains more accurate results by using information from one or more viewpoints to select the best pose subspace from a distribution of poses generated by the machine learning model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example pose estimation visual system.

FIG. 2 is an example of images from different viewpoints of an object with pose ambiguity.

FIG. 3 is an example of subspaces that are partitioned in an object space for an object with pose ambiguity.

FIG. 4 is an example of an object with symmetry-like pose ambiguity.

FIG. 5 is an example of an object with occluded features.

FIG. 6 is a flow diagram of an example process for generating a predicted pose for an object by partitioning the object space into subspaces.

### DETAILED DESCRIPTION

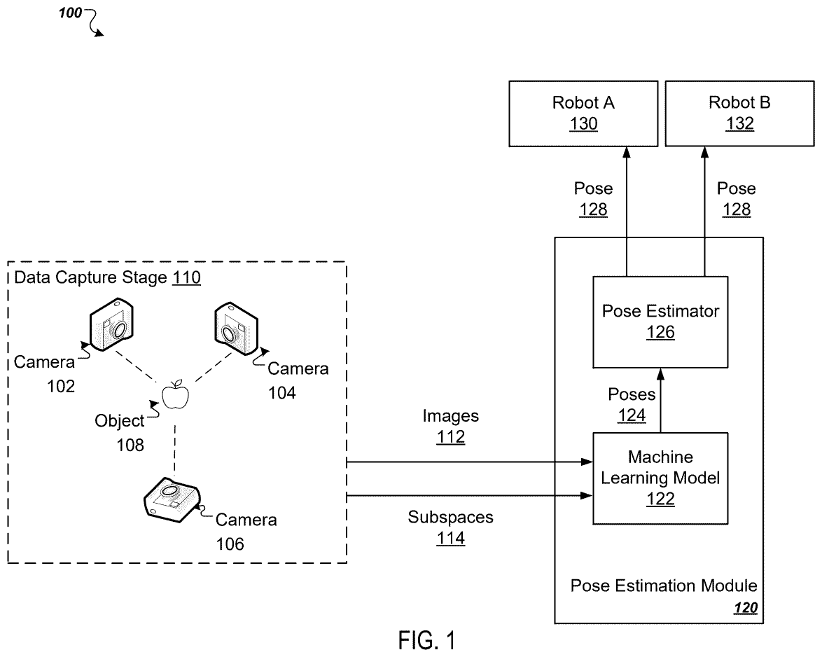

FIG. 1 is a diagram that illustrates an example pose estimation visual system 100. The system 100 is an example of a system that can implement the techniques described in this specification. The example system 100 is a system implemented on one or more computers in one or more locations, in which systems, components, and techniques described below can be implemented. Some of the components of the system 100 can be implemented as computer programs configured to run on one or more computers.

In particular, the pose estimation visual system 100 is configured to estimate a pose of an object of interest captured in an image. The object of interest can include components in an execution environment of a robotic system, including objects to be manipulated by a robot, or a robot. The system 100 can be included in a robotic system, but in some implementations, the system 100 can be external to a robotic system. The system 100 can be generally used for other suitable systems, e.g., an autonomous driving system.

As shown in FIG. 1, the pose estimation visual system 100 includes a data capture stage 110 and a pose estimation module 120. The pose estimation module 120 is configured to receive as input (i) a plurality of input images 112 capturing an object 108 of interest and (ii) subspace data 114 associated with the object 108 from the data capture stage 110. The object 108 captured in the images 112 has a particular pose (e.g., in a particular position and orientation). The pose estimation module 120 is configured to predict an output pose for the object 108 in the images 112 after processing the above-noted input.

During the data capture stage 110, a camera 102, a camera 104, and a camera 106 are set up to capture images of object 108 from their respective viewpoints within a predetermined subspace. The object space of object 108 is partitioned into a plurality of subspaces to eliminate ambiguous viewpoints of the object 108. Subspaces for an object may vary in number and location within the object space based on the object. For example, the object space may be carved into two hemispherical subspaces for an object with convex-concave pose ambiguity. In some implementations, the subspaces are determined by a machine learning model. In some implementations, the subspaces are manually chosen.

The pose estimation module 120 includes a machine learning model 122 and a pose estimator 126. The pose estimation module 120 is configured to process the input images 112 capturing the object and the subspace data 114 and to generate a pose for the object 108.

The machine learning model 122 can receive as input the images 112 of the object 108 and the subspaces 114 in which the images 112 were captured. The subspace data 114 is a set of subspaces partitioned from the object space of the object 108 and is dependent on the pose ambiguity of the object 108. For example, for an object that has convex-concave ambiguity in which it is difficult to distinguish an image taken from a concave viewpoint of an object from an image taken from a convex viewpoint, the object space can be partitioned into two subspaces: one containing the concave portion of the object and one containing the convex portion. Moreover, the machine learning model 122 can receive a set of images 112 of different viewpoints belonging to the subspaces 114 and generates a predicted pose for each subspace from the images belonging to the specific subspace. When predicting poses, the machine learning model 122 is forced to pose the object in a way that belongs to the selected subspace. For example, for two hemispherical subspaces belonging to an object with convex-concave ambiguity, the pose for the first hemispherical subspace containing the concave portion of the object has to be a concave pose e.g., a pose showcasing the concave portion of the object facing towards the camera. In this particular example, the convex portion of the object is not captured by any of the viewpoints belonging to the concave subspace and therefore, the machine learning model can only output a pose of the object that belongs to the concave subspace. The machine learning model 122 can do this for every subspace that is partitioned for the object 108, generating a predicted pose for each subspace. The machine learning model 122 then sends as output a distribution of poses 124 of the object 108, one pose belonging to each of the subspaces, to the pose estimator 126.

In some implementations, the machine learning model generates features for each of the images 112 of the object belonging to a subspace from the subspace data 114 and uses the generated features to generate a pose belonging to the subspace. The features may include joints or corners of objects, edges, outlines or silhouettes, or any other detectable characteristic in object images. For example, in an image of a straight backed four-legged chair, the features can include the four legs, the edges of the seat, and the corners of the backrest. These features will be found in different locations on the images obtained from different viewpoints based on the pose of the chair. For example, the corners of the backrest will show up differently in a viewpoint from the front of the chair and the side of the chair with some not even showing in the side image. The differences in the features across viewpoints will help predict the pose of the chair.

In some implementations, the generated features can be keypoints belonging to the object 108. In some examples, keypoints can indicate joints, edges, corners, facial features, connection points, and outlines. The machine learning model 122 then can use a keypoint based estimation system to generate the predicted pose for a subspace from the subspace data 114 using the generated keypoints of the object from the images 112. In particular, the machine learning model 122 can receive the images 112 of the object belonging to the subspace and extract keypoints from the images. The machine learning model 122 then performs an optimization process that aligns the 2D keypoints extracted from the images of the object with the 3D keypoints on the object to generate a predicted pose of the object belonging to the subspace.

The pose estimator 126 receives as input a distribution of poses 124, comprising the best pose for each subspace, from the machine learning model. The pose estimator 126 determines the pose of the object 108 that is the most accurate from different subspace poses 124 and provides as output the final pose 128 to robot A 130 and robot B 132. In some implementations, the pose estimator 126 may compute a confidence value for each predicted pose to determine the best pose. The confidence value is a measure of how well the predicted pose corresponds to the feature predictions of the object. For example, the pose estimator 126 may utilize an optimization function to compute a confidence value for each of the plurality of poses. The pose with the highest confidence value is then determined to be the estimated pose of the object 108. The delayed choice of pose allows for more accurate pose estimation as the pose estimator has more information regarding the predicted poses from multiple viewpoints and can compare poses to choose the best one.

Robot A 130 and Robot B 132 can take as input the estimated pose of the object 108. In some implementations, the estimated pose is used by the robot to perform a variety of movements. For example, the robot can use the estimated pose to help pick up the object e.g., if the object is a mug, the robot can pick up the mug the best way, by the handle or by the body, depending on the mug's pose.

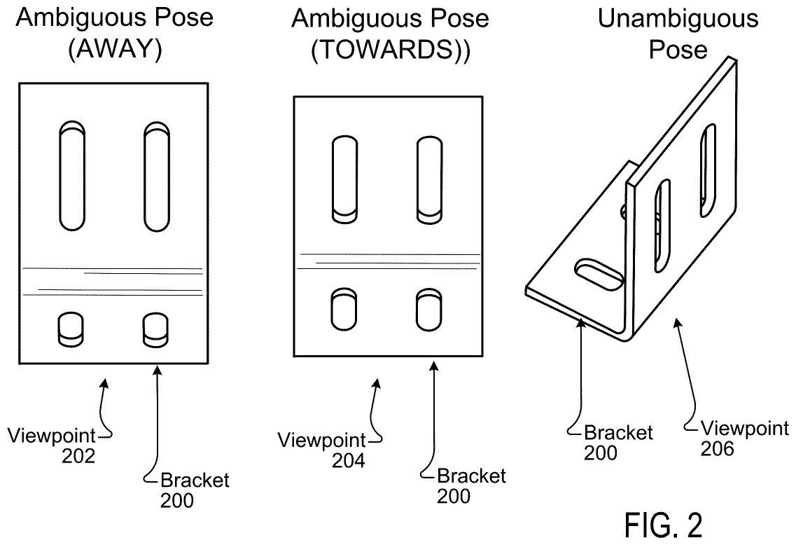

FIG. 2 depicts an example of images obtained from different viewpoints of a bracket 200 with pose ambiguity and demonstrates how images can lack distinctive features that would distinguish poses from one another. FIG. 2 additionally illustrates a specific example of convex-concave ambiguity with bracket 200.

In the particular example depicted, three images can be obtained from three different viewpoints e.g., viewpoint 202, viewpoint 204 and viewpoint 206 that capture distinct views of the bracket 200. The number of viewpoints is not restricted to the three demonstrated in this example and images can be obtained from any number of viewpoints.

In this example, the viewpoint 202 captures a convex orientation of the bracket 200 e.g., where the short side of the bracket is facing away from the camera, the viewpoint 204 captures a concave orientation of the bracket 200 e.g., where the short side facing towards the camera, and the viewpoint 206 captures a sideways orientation of the bracket 200. As demonstrated in FIG. 2, the convex view from viewpoint 202 and the concave view from viewpoint 204 are ambiguous. For a pose estimator, it may be difficult to find a distinction between the two viewpoints as the features identified within the image would be too similar. A pose estimator would then be unable to accurately determine which direction the bracket is facing to estimate its pose.

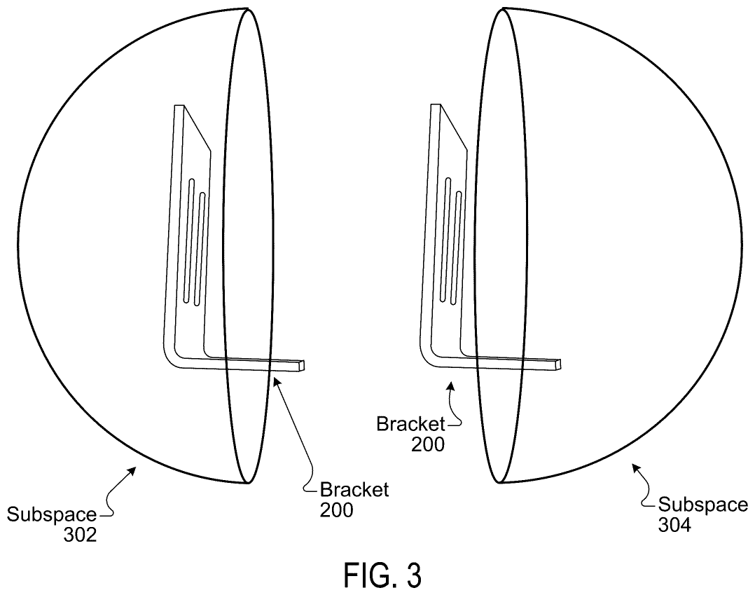

FIG. 3 depicts an example of a potential subspace partition of the object space for the bracket of FIG. 2. An object space can be partitioned into M subspaces to eliminate pose ambiguity. As demonstrated in FIG. 2, the bracket 200 has convex-concave ambiguity that appears in viewpoint 202 and viewpoint 204 as the convex pose in viewpoint 202 and the concave pose in viewpoint 204 are unable to be distinguished from one another.

In this particular example, the object space of the bracket 200 is partitioned into two hemispherical subspaces 302 and 304. The first hemispherical subspace 302 contains the convex portion of the bracket 200, and the second hemispherical subspace 304 contains the concave portion of the bracket 200. By partitioning the object space into subspaces, it not only simplifies the object space for the machine learning model 122 but partitions the viewpoints into their respective subspaces. For example, the ambiguous convex view from viewpoint 202 and the unambiguous side view from viewpoint 306 belong to subspace 302 as the short side of the bracket is facing away from the camera while the ambiguous concave view from viewpoint 204 belongs to subspace 304.

The machine learning model 122 can receive images 112 from viewpoints belonging to a specific subspace as well as the subspaces 114. For example, the machine learning model 122 may receive subspace 302 and the two images from its respective viewpoints 202 and 206 and subspace 304 and an image from its respective viewpoint 204.

The machine learning model 122 then generates a predicted set of features for each image obtained for each subspace. In particular, the machine learning model 122 generates features for both images from viewpoints 202 and 206 and features for the image from viewpoint 204.

In some examples, the generated features can be keypoints. For the example depicted in FIG. 2, the keypoints of the bracket 200 may include edges, the outmost corners, the oval cutouts within the bracket and the connection of the two pieces (as seen in viewpoint 206). In this example, the keypoints can be detected through a keypoint prediction equation for each subspace b for M subspaces:

K_{b}={φ(I^{k}|b), k=1, 2, . . . , N} for b=1, 2, . . . , M where K_{b} are the keypoints predicted for each image I^{k} belonging to a subspace b for M subspaces.

The keypoint prediction equation can predict 2D keypoints on images of an object, acting under the assumption that the object pose in the image is restricted to viewpoints for the corresponding subspace. For example, viewpoints 202 and 206's keypoints will be generated under the assumption that the convex portion of the bracket is facing away the cameras that obtained the images, while the keypoints in viewpoint 204 will be generated under the assumption that the concave portion of bracket 200 is facing towards from the camera that obtained the image.

For each subspace, the set of keypoints K_{M} predicted can then be used to compute an object pose P_{M} for each of the M pose subspaces to get M pose candidates using a multiview perspective-n-point algorithm:

$$\begin{matrix}{P}_{1} = mvPnP ( {K}_{1} ) , \\ {P}_{2} = mvPnP ( {K}_{2} ) , \\ … , \\ {P}_{M} = mvPnP ( {K}_{M} )\end{matrix}$$

The machine learning model 122 can utilize the set of features predicted from each image belonging to the subspace to generate one pose candidate for each subspace. For example, keypoints generated from viewpoint 202 and 206 can be used to generate a pose for subspace 302 and the keypoints generated from viewpoint 204 can be used to generate a pose for subspace 304. In particular, the machine learning model can generate a convex pose for subspace 302 and a concave pose for subspace 304. The convex pose shown in subspace 302 can be denoted as AWAY and the concave pose shown in subspace 304 as TOWARDS.

Then, the machine learning model 122 can compute the confidence measure of each of the M pose candidates. In some implementations, the confidence measure can be computed by analyzing each image I^{k} captured of the object to determine if the image belongs to the predicted pose P_{M} for each M subspace:

$$\begin{matrix}{c}_{1} = {\sum }_{k = 1}^{N} {Conf}_{k} ( {P}_{1} , ϕ ( {I}^{k} \vert 1 ) ) , \\ {c}_{2} = {\sum }_{k = 1}^{N} {Conf}_{k} ( {P}_{2} , ϕ ( {I}^{k} \vert 2 ) ) , \\ … , \\ {c}_{M} = {\sum }_{k = 1}^{N} {Conf}_{k} ( {P}_{M} , ϕ ( {I}^{k} \vert M ) ) .\end{matrix}$$

The machine learning model 122 can utilize the confidence equation on each of the M pose candidates, P_{M}, to determine which matches the pose of the object the best. For example, the machine learning model 122 can compute the confidence of both the AWAY and TOWARDS poses based on the images obtained of the object.

For example, if the correct pose is the convex pose i.e., AWAY pose, belonging to subspace 302, the overall confidence value of the AWAY pose will be higher.

For this particular example, if the machine learning model receives images from viewpoint 204 and viewpoint 206 with the image from viewpoint 204 denoted as the left image and the image from viewpoint 206 as the right image, it can model the ambiguity between the AWAY and TOWARD poses with the assumption that the confidence of both is the same in the left image:

$${Conf}_{left} ( AWAY , ϕ ( {I}^{left} \vert AWAY ) ) = {Conf}_{left} ( TOWARD , ϕ ( {I}^{left} \vert TOWARD ) ) = 1.$$

However, the right image is unambiguous, i.e., it is clear that the object is in the AWAY pose as the short side of the bracket 200 is facing away, which can be modeled by setting:

$$\begin{matrix}{Conf}_{right} ( AWAY , ϕ ( {I}^{right} \vert AWAY ) ) = 1 and \\ {Conf}_{right} ( TOWARD , ϕ ( {I}^{right} \vert TOWARD ) ) = 0.\end{matrix}$$

The machine learning model then can calculate the overall confidence of the poses by adding the confidence of the images:

$$\begin{matrix}{c}_{AWAY} = {Conf}_{left} ( AWAY , ϕ ( {I}^{left} \vert AWAY ) ) + {Conf}_{right} ( AWAY , ϕ ( {I}^{right} \vert AWAY ) ) = 1 + 1 = 2 , \\ {c}_{TOWARD} = {Conf}_{left} ( TOWARD , ϕ ( {I}^{left} \vert TOWARD ) ) + {Conf}_{right} ( TOWARD , ϕ ( {I}^{right} \vert TOWARD ) ) = 1 + 0 = 1\end{matrix}$$

In this particular example, the overall confidence score of a predicted pose can be calculated by analyzing each image obtained of the object and determining the confidence that the object, in each image, is in the predicted pose. As demonstrated in the above equations, the overall confidence value is able to disambiguate the AWAY and TOWARDS poses through the images obtained of the object.

Then, the system determines the best base pose according to the confidence score: b*=argmax_{b} c_{b}. In the example given above, the AWAY pose has the higher confidence score and is the better predicted pose, correctly outputted by the machine learning model 122.

Finally, the visual pose estimation system provides the pose with the best score P_{b*} as the final output pose P:

$$P = {P}_{{b}^{*}} = mvPnP ( {K}_{{b}^{*}} )$$

As demonstrated through the example, the pose estimation visual system delays the disambiguation step until the system has information i.e., predicted poses, from multiple views. The pose estimation visual system has images 112 obtained from different viewpoints of the object as well as multiple predicted poses from which to choose. The delayed computation is more likely to succeed as it is choosing the best pose from a distribution of poses generated by the model.

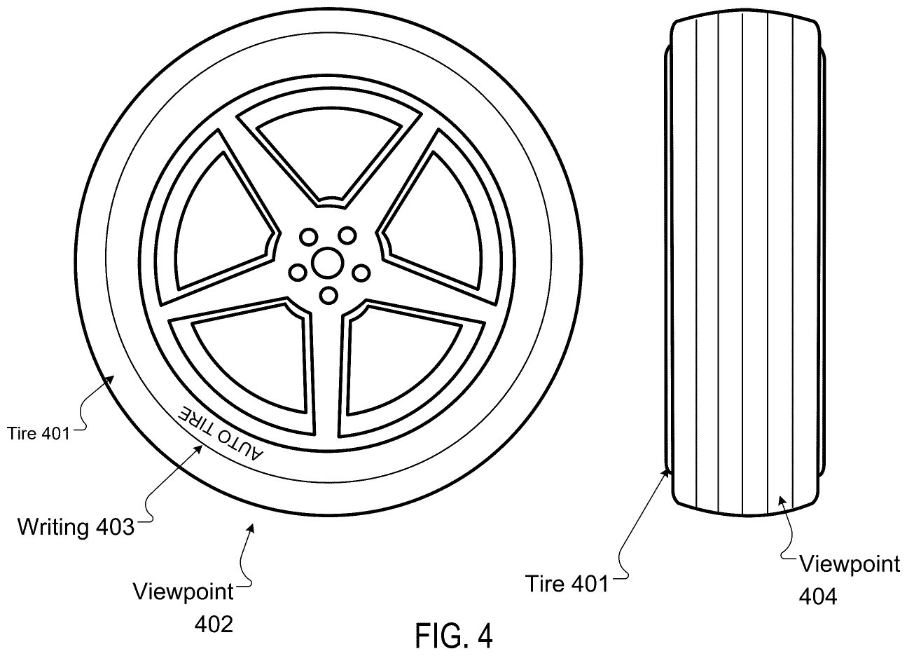

FIG. 4 depicts an example of an object with symmetrical pose ambiguity. The side view of the wheel illustrated in viewpoint 402 is unambiguous because of unique features of the tire 401 e.g., the writing 403 on the side. However, the front view of the tire 401 in viewpoint 404 is ambiguous as all the distinctive features that make the tire non-symmetric are occluded by the tire itself. Since each confidence measure is completely independent of the other poses, different symmetry handling solutions can be applied to different views. In the example of the tire shown in FIG. 4, the side view of the tire does not need any symmetry handling rule as it is unambiguous. However, a standard continuous symmetry handling rule can be applied to the front view of the tire.

One possible implementation could be a modified design of the mvPnP(K) function.

A typical approach that does not account for symmetry could be as follows

$$mvPnP ( K ) = arg {min}_{P} {\sum }_{k = 1}^{N} {‖ ϕ ( {I}^{k} ) - {S}_{k} P K ‖}^{2}$$

where P is the object pose in world coordinate system, and Sₖ denotes the 2D projection of 3D object keypoints onto image plane of camera k. The problem with this approach is that it is impossible to design or train accurate φ(I^{k}) for objects with symmetry.

A typical approach that does account for continuous symmetry but does not benefit our implementation would be

$$mvPnP ( K ) = arg {min}_{P} {min}_{0 \leq {θ}_{1} , … , {θ}_{N} \leq 360} {\sum }_{k = 1}^{N} {‖ ϕ ( {I}^{k} ) - {S}_{k} P {R}_{{θ}_{k}} K ‖}^{2}$$

where R_{θ}_{ₖ} is a rotation around symmetry axis by θₖ degrees. The disadvantage is that the returned pose P is only determined up to a rotation about the symmetry axes.

In a possible approach that accounts for symmetry and benefits our implementation, the base pose subspaces could be introduced as follows. The first subspace will include all orientations of the tire where there is no symmetrical ambiguity, such as viewpoint 402. The second subspace contains the rest of the object orientations, i.e., the orientations of the tire where there is symmetrical ambiguity. In this particular example, cameras can be positioned at the viewpoints 402 and 404. Then, the machine learning model can use the equations shown below to estimate the pose of the tire:

$$\begin{matrix}mvPnP ( {K}_{402} ) = arg {min}_{P} {min}_{0 \leq {θ}_{404} \leq 360} {‖ ϕ ( {I}^{402} ) - P K ‖}^{2} + {‖ ϕ ( {I}^{404} ) - P {R}_{{θ}_{404}} K ‖}^{2} and \\ mvPnP ( {K}_{404} ) = arg {min}_{P} {min}_{0 \leq {θ}_{402} \leq 360} {‖ ϕ ( {I}^{402} ) - P {R}_{{θ}_{402}} K ‖}^{2} + {‖ ϕ ( {I}^{404} ) - P K ‖}^{2} .\end{matrix}$$

That is, the system selectively applies a rotation matrix depending on whether the base pose of the object is symmetrically ambiguous from the specific camera viewpoint. This approach has a unique advantage over the previous approach as it allows the model to identify the exact pose of the object whereas the other approach only gives the pose up to a rotation around symmetry axes.

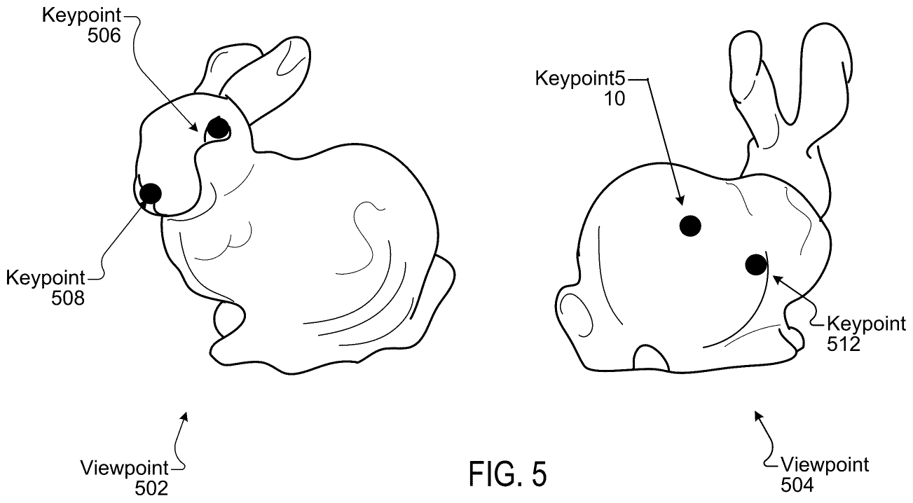

FIG. 5 depicts an example of an object with occluded features i.e., features that do not show up in some viewpoints of the object. In some implementations, a keypoint estimation system can be used to generate a pose for this object. Due to inevitable self-occlusions, the keypoint prediction system will experience difficulty in predicting the locations of occluding keypoints. For example, viewpoints 502 and 504 have different keypoints. Keypoints 506 and 508 are only visible in viewpoint 502 and keypoints 510 and 512 are only visible in viewpoint 504. It is extremely difficult to predict the location of either keypoint 506 or 508 in viewpoint 504 as they could appear anywhere inside the bunny silhouette from viewpoint 502.

By partitioning the object space into subspaces and generating keypoints from images belonging to a specific subspace, the machine learning model 122 only predicts visible keypoints in each subspace, improving overall accuracy of the keypoints. The processing of keypoints with respective to different subspaces is independent so the system can choose to have a different set of 3D keypoints when performing the optimization function for images from viewpoint 502 and 504. To account for occlusions, for each subspace, the machine learning model can choose 3D keypoints that are visible within the subspace. For example, suppose the orientation space was partitioned into 2 base poses and the two images in viewpoint 504 and viewpoint 504 are representative poses for each subspace. Then, the confidence equation would adjust to include keypoints K:

$$c ( P , K ) = {Conf}_{left} ( P , {ϕ}_{first} ( {I}^{left} ) ) + {Conf}_{right} ( P , {ϕ}_{second} ( {I}^{right} ) )$$

Here φ_{first}, predicts 2D locations of keypoints 506 and 508 and φ_{predicts} 2D locations of keypoints 510 and 512, allowing the system to adapt to the different keypoints while maintaining accuracy.

The embodiments described in this specification can be used to solve a number of pose ambiguity problems in pose estimation and are not limited to the ones described in this specification.

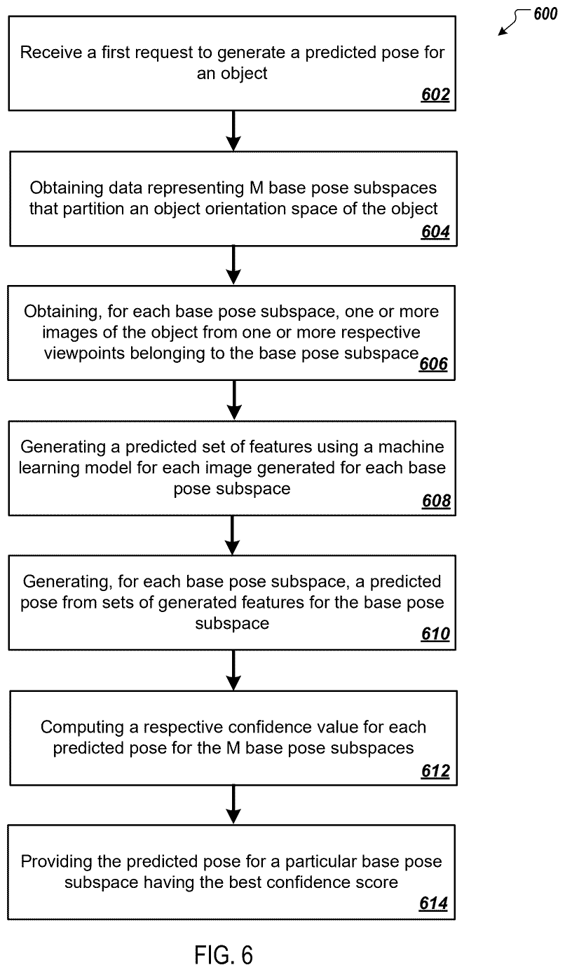

FIG. 6 is a flow diagram of an example process for generating a predicted pose for an object by partitioning the object space into subspaces. For convenience, the process 600 will be described as being performed by a system of one or more computers located in one or more locations. For example, a pose estimation subsystem, e.g., the pose estimation module 120 in the pose estimation visual system 100 of FIG. 1, appropriately programmed in accordance with this specification, can perform the process 600.

In particular, the system can first receive a request to generate a predicted pose for an object (step 602). The object of interest can include components in an execution environment of a robotic system, including objects to be manipulated by a robot, or a robot. In some cases, the request can come from the robotic system.

The system can obtain data representing M base pose subspaces that partition an object orientation space of the object (step 604) to eliminate pose ambiguity. The object space can be partitioned manually into any number of subspaces addressing any type of pose ambiguity. As an example, the object orientation space can be partitioned into two hemispherical subspaces to eliminate convex-concave ambiguity. In some cases, the subspaces can be partitioned by a machine learning model.

The system can then obtain, for each pose subspace, one or more images of the object from one or more respective viewpoints belonging to the base pose subspace (step 606). The images can be obtained from one or more cameras in an object environment. In some cases, the images can be obtained from one or more cameras within a robotic execution environment where the object is located.

The system can generate a predicted set of features using a machine learning model for each image generated for each base pose subspace (step 608). As an example, features may include edges, corners, outlines, or contours of the object. In some implementations, the features can be keypoints extracted from the images.

In particular, the system can then generate, for each base pose subspace, a predicted pose from sets of generated features for the base pose subspace (step 610). In some implementations, the system can utilize extracted keypoints and a keypoint based estimation system to generate a pose of the object. Moreover, the system can perform an optimization process that aligns the 2D keypoints extracted from the images of the object with the 3D keypoints on the object to generate a predicted pose of the object belonging to the subspace.

The system can compute a respective confidence value for each predicted pose for the M base pose subspaces (step 612). The confidence value is a measure of how well the predicted 3D pose corresponds to the 2D feature predictions. In some cases, the confidence value is computed using an optimization function. In some implementations, the confidence value can be computed using statistical methods. For example, the confidence value can be computed using the reprojection error method in which the distance between a point corresponding to the predicted pose and the actual point measured in step 608 is calculated. In some implementations, the confidence value can be computed using a mix of the statistical and optimization methods.

The system can then provide the predicted pose for a particular base pose subspace having the best confidence score (step 614). In some implementations, the system provides the predicted pose with the highest confidence score.

In this specification, convex-concave ambiguity refers to the difficulty in distinguishing concave e.g., inward curving, or convex e.g., outward-curving viewpoints of an object. Convex-concave ambiguity may be caused by insufficient or misleading visual cues in images of the object.

In this specification, symmetrical ambiguity refers to the difficulty in accurately determining the pose of an object that has symmetrical features. Symmetrical ambiguity arises because symmetrical objects can appear identical from multiple viewpoints.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving a request to generate a predicted pose for an object;
obtaining data representing M base pose subspaces that partition an object orientation space of the object;
obtaining, for each base pose subspaces of the M base pose subspaces, one or more images of the object from one or more respective viewpoints belonging to the base pose subspace;
generating, for each base pose subspace, a predicted pose from features obtained from the images of the object from one or more respective viewpoints belong to the base pose subspace, utilizing a pose estimation method;
computing a respective confidence value for each predicted pose for the M base pose subspaces; and
providing the predicted pose for a particular base pose subspace having the best confidence score.

Embodiment 2 is the method of embodiment 1, wherein the pose estimation method uses keypoint generation.

Embodiment 3 is the method of embodiment 2, further comprising predicting a set of keypoints for pose estimation by using a machine learning model that takes as input an identifier of a base pose subspace and that is configured to generate a set of keypoints consistent with an object pose belonging to the identified base pose subspace.

Embodiment 4 is the method of any one of embodiments 1-3, wherein the M base pose subspaces are specific to the type of object.

Embodiment 5 is the method of embodiment 4, further comprising using a different partitioning of an object orientation space for a different type of object.

Embodiment 6 is the method of embodiment 4, wherein the partitioning of base pose subspace is based on a pose ambiguity of the type of object.

Embodiment 7 is the method of any one of embodiments 2-6, wherein generating a predicted pose from the set of keypoints comprises performing an optimization process that aligns 2D keypoints in images with 3D keypoints on the object.

Embodiment 8 is the method of embodiment 7, wherein performing the optimization process for each base pose subspace comprising using only keypoints generated by the machine learning model to be consistent with an object pose belonging to the base pose subspace.

Embodiment 9 is the method of any one of embodiments 1-8, wherein computing a confidence value for each predicted pose for the M base pose subspaces assigns a substantially identical confidence score for ambiguous pairs of poses.

Embodiment 10 is the method of any one of embodiments 1-9, wherein the particular base pose subspace having the best confidence score is determined using predicted poses from all base pose subspaces.

Embodiment 11 is the method of embodiment 10, wherein the provided predicted base poses is determined using keypoints from only one base pose subspace.

Embodiment 12 is the method of any one of embodiments 1-11, wherein the object has an away or toward ambiguity and wherein the partitioning of the object orientation space of the object comprises two halves of a sphere.

Embodiment 13 is the method of any one of embodiments 1-12, wherein a predicted pose is generated using a symmetry handling rule for an object that has symmetrical ambiguity.

Embodiment 14 is the method of any one of embodiments 1-13 wherein the confidence value is a measure of how well the predicted pose corresponds to the feature predictions.

Embodiment 15 is a system comprising: one or more computers and one or more storage devices storing instructions that are operable, when executed by the one or more computers, to cause the one or more computers to perform the method of any one of embodiments 1 to 14.

Embodiment 16 is a computer storage medium encoded with a computer program, the program comprising instructions that are operable, when executed by data processing apparatus, to cause the data processing apparatus to perform the method of any one of embodiments 1 to 14.

While this specification contains many specific implementation details, these should not be construed as limitations on the scope of any invention or on the scope of what may be claimed, but rather as description of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combination and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood that the described program components and system can generally be integrated together in a single software product or packaged into multiple software products.

Particular embodiments of the subject matter have been described. Other embodiments are within the scope of the following claims. For example, the actions recited in the claims can be performed in a different order and still have achievable results. As one example, the processes depicted in the accompanying figures do not necessarily require the particular order shown, or sequential order, to achieve desirable results. In some cases, multitasking and parallel processing may be advantageous.

What is claimed is:

1. A computer implemented method comprising:
receiving a request to generate a predicted pose for an object;
obtaining data representing M base pose subspaces that partition an object orientation space of the object;
obtaining, for each base pose subspaces of the M base pose subspaces, one or more images of the object from one or more respective viewpoints belonging to the base pose subspace;
generating, for each base pose subspace, a predicted pose from features obtained from the images of the object from one or more respective viewpoints belong to the base pose subspace, utilizing a pose estimation method;
computing a respective confidence value for each predicted pose for the M base pose subspaces; and
providing the predicted pose for a particular base pose subspace having the best confidence score.

2. The method of claim 1, wherein the pose estimation method uses keypoint generation.

3. The method of claim 2, further comprising predicting a set of keypoints for pose estimation by using a machine learning model that takes as input an identifier of a base pose subspace and that is configured to generate a set of keypoints consistent with an object pose belonging to the identified base pose subspace.

4. The method of claim 1, wherein the M base pose subspaces are specific to the type of object.

5. The method of claim 4, further comprising using a different partitioning of object orientation space for a different type of object.

6. The method of claim 4, wherein the partitioning of base pose subspace is based on a pose ambiguity of the type of object.

7. The method of claim 2, wherein generating a predicted pose from the set of keypoints comprises performing an optimization process that aligns 2D keypoints in images with 3D keypoints on the object.

8. The method of claim 7, wherein performing the optimization process for each base pose subspace comprising using only keypoints generated by the machine learning model to be consistent with an object pose belonging to the base pose subspace.

9. The method of claim 1, wherein computing a confidence value for each predicted pose for the M base pose subspaces assigns a substantially identical confidence score for ambiguous pairs of poses.

10. The method of claim 1, wherein the particular base pose subspace having the best confidence score is determined using predicted poses from all base pose subspaces.

11. The method of claim 10, wherein the provided predicted base poses is determined using keypoints from only one base pose subspace.

12. The method of claim 1, wherein the object has an away or toward ambiguity and wherein the partitioning of the object orientation space of the object comprises two halves of a sphere.

13. The method of claim 1 wherein a predicted pose is generated using a symmetry handling rule for an object that has symmetrical ambiguity.

14. The method of claim 1 wherein the confidence value is a measure of how well the predicted pose corresponds to the feature predictions.

15. A system comprising one or more computers and one or more storage devices storing instructions that are operable, when executed by the one or more computers to cause the one or more computers to perform operations comprising:
receiving a request to generate a predicted pose for an object;
obtaining data representing M base pose subspaces that partition an object orientation space of the object;
obtaining, for each base pose subspaces of the M base pose subspaces, one or more images of the object from one or more respective viewpoints belonging to the base pose subspace;
generating, for each base pose subspace, a predicted pose from features obtained from the images of the object from one or more respective viewpoints belong to the base pose subspace, utilizing a pose estimation method;
computing a respective confidence value for each predicted pose for the M base pose subspaces; and
providing the predicted pose for a particular base pose subspace having the best confidence score.

16. The system of claim 15, wherein the M base pose subspaces are specific to the type of object.

17. The system of claim 16, further comprising using a different partitioning of object orientation space for a different type of object.

18. The system of claim 16, wherein the partitioning of base pose subspace is based on a pose ambiguity of the type of object.

19. The system of claim 15, wherein the particular base pose subspace having the best confidence score is determined using predicted poses from all base pose subspaces.

20. A non-transitory computer storage medium encoded with a computer program, the program comprising instructions that are operable, when executed by data processing apparatus to cause the data processing apparatus to perform operations comprising:
receiving a request to generate a predicted pose for an object;
obtaining data representing M base pose subspaces that partition an object orientation space of the object;
obtaining, for each base pose subspaces of the M base pose subspaces, one or more images of the object from one or more respective viewpoints belonging to the base pose subspace;
generating, for each base pose subspace, a predicted pose from features obtained from the images of the object from one or more respective viewpoints belong to the base pose subspace, utilizing a pose estimation method;
computing a respective confidence value for each predicted pose for the M base pose subspaces; and
providing the predicted pose for a particular base pose subspace having the best confidence score.
